(19) United States
(12) Patent Application Publication
(10) Pub. No.: US 2023/0399264 A1
(43) Pub. Date: Dec. 14, 2023

(54) BORON NITRIDE POWDER AND METHOD FOR PRODUCING BORON NITRIDE POWDER

(71) Applicant: Denka Company Limited, Chuo-ku, Tokyo (JP)

(72) Inventors: Go TAKEDA, Tokyo (JP); Hiroyuki SHIOTSUKI, Tokyo (JP); Takaaki TANAKA, Tokyo (JP)

(73) Assignee: Denka Company Limited, Chuo-ku, Tokyo (JP)

(21) Appl. No.: 18/246,811

(22) PCT Filed: Sep. 27, 2021
(86) PCT No.: PCT/JP2021/035394

§ 371 Date: Mar. 27, 2023

(30) Foreign Application Priority Data
Sep. 30, 2020 (JP) 2020-165642

(51) Int. Cl. C04B 35/583; C04B 35/626

(52) U.S. Cl. CPC C04B 35/583; C04B 35/62645; C04B 2235/5409; C04B 2235/5436; C04B 2235/386

(57) ABSTRACT

One aspect of the present disclosure provides a boron nitride powder containing agglomerated particles formed by agglomeration of primary particles of hexagonal boron nitride, in which a degree of purity is 98.5% by mass or more, and a number of particles containing carbon is 10 or less per 10 g of the boron nitride powder.

### TECHNICAL FIELD

The present disclosure relates to a boron nitride powder and a production method of a boron nitride powder.

### BACKGROUND ART

Hexagonal boron nitride has excellent lubricity, high thermal conductivity, insulation properties, and the like. Therefore, hexagonal boron nitride is used in various applications such as a filler for heat dissipation materials, a solid lubricating material, a release material for gasifier gas and aluminum, a raw material for cosmetic products, and a raw material for sintered bodies.

For example, Patent Literature 1 proposes a hexagonal boron nitride powder that can increase the thermal conductivity and withstand voltage (dielectric breakdown voltage) of a resin and the like when used as a filler for an insulation and heat dissipation material such as the above-mentioned resin, and a production method thereof.

### CITATION LIST

### Patent Literature

[Patent Literature 1] Japanese Unexamined Patent Publication No. 2019-116401

### SUMMARY OF INVENTION

### Technical Problem

As electronic components such as power devices, transistors, thyristors, and CPUs become more sophisticated, performances of members used in these electronic components are also required to be improved. For example, in the case in which electronic components are used at a high voltage for a long period of time, a heat-transmitting sheet incorporated in the electronic components is also required to have better insulation properties. A boron nitride powder is used as a material constituting the heat-transmitting sheet together with a resin, but according to studies of the inventors of the present invention, dielectric breakdown and the like of the heat-transmitting sheet may occur in the use environment as described above even in the case of using a conventional boron nitride powder which has been thought to have a sufficiently high degree of purity and an excellent performance.

An object of the present disclosure is to provide a boron nitride powder having a better insulation performance when used as a filler than the conventional boron nitride powder, and a production method of the boron nitride powder.

### Solution to Problem

The inventors of the present invention conducted detailed analysis of the conventional boron nitride powder having a high degree of purity to study the influences thereon when using it for a heat-transmitting sheet. They found during the study that in the environment in which a trace amount of particles containing carbon (carbon-containing particles), which were previously presumed to be no problem, are exposed to a high voltage, the particles may have an influence on the performance of products such as heat-transmitting sheets, and the present invention was completed based on this finding.

One aspect of the present disclosure provides a boron nitride powder containing agglomerated particles formed by agglomeration of primary particles of hexagonal boron nitride, in which a degree of purity is 98.5% by mass or more, and a number of particles containing carbon is 10 or less per 10 g of the boron nitride powder.

Since the above-mentioned boron nitride powder has a high degree of purity and a reduced content of carbon-containing particles, the boron nitride powder has an excellent insulation performance when used as a filler. The insulation performance in the present disclosure is a performance evaluated under conditions more severe than conventional conditions. Specifically, the insulation performance in the present disclosure is a performance evaluated based on the current-carrying condition of applying a direct voltage of 1100 V to a resin composition prepared from the boron nitride powder and a resin in the environment of 65° C. and 90 RH % until dielectric breakdown occurs.

The above-mentioned number of particles containing carbon may be 0.05 to 10 per 10 g of the boron nitride powder.

In the above-mentioned boron nitride powder, an amount of impurity carbon may be 170 ppm or less.

In the above-mentioned boron nitride powder, a graphitization index may be 2.3 or less. When the graphitization index of the primary particles is within the above-mentioned range, the boron nitride powder has a better insulation performance.

In the above-mentioned boron nitride powder, an average particle size may be 7 to 100 μm, and a specific surface area may be 0.8 to 8.0 m²/g. When the average particle size and the specific surface area are within the above-mentioned ranges, thermal conductivity may also be improved in the boron nitride powder in addition to the insulation properties. Therefore, the boron nitride powder can be used more suitably as a filler for preparing a heat-transmitting sheet having an excellent insulation performance and an excellent heat dissipation performance.

Another aspect of the present disclosure provides a production method of a boron nitride powder, the method including heat-treating a raw material powder at a temperature of 500° C. or higher in an atmosphere in which an oxygen proportion is 15% by volume or more, the raw material powder containing agglomerated particles that are formed by agglomeration of primary particles and containing hexagonal boron nitride in which a degree of purity is 98.0% by mass or more.

In the above-mentioned production method of a boron nitride powder, the boron nitride powder as described above can be produced by further heat-treating the raw material powder of boron nitride having a high degree of purity under the condition of a certain amount or more of oxygen being contained.

An orientation index of the above-mentioned raw material powder may be 30 or less.

A graphitization index of the above-mentioned raw material powder may be 2.3 or less.

### Advantageous Effects of Invention

According to the present disclosure, a boron nitride powder having a better insulation performance when used as a filler than the conventional boron nitride powder, and a production method of the boron nitride powder can be provided.

### DESCRIPTION OF EMBODIMENTS

Hereinafter, embodiments of the present disclosure will be described. However, the following embodiments are examples for explaining the present disclosure and are not intended to limit the present disclosure to the following contents.

For materials exemplified in the present specification, one type may be used alone, or two or more types may be used in combination unless explicitly described otherwise. When a plurality of substances corresponding to each of components in a composition are present, the content of each of the components in the composition means the total amount of the plurality of substances present in the composition unless explicitly described otherwise. The “steps” in the present specification may be steps independent of each other or may be steps performed at the same time.

[Boron Nitride Powder]

One embodiment of a boron nitride powder contains agglomerated particles formed by agglomeration of primary particles of hexagonal boron nitride. In the above-mentioned boron nitride powder, the degree of purity is 98.5% by mass or more, and the number of particles containing carbon is 10 or less per 10 g of the boron nitride powder.

Hexagonal boron nitride may be such that there is less variation in the shape of the primary particles. The shape of the primary particles of hexagonal boron nitride may be flake-like, disk-like, and the like.

The degree of purity of the boron nitride powder may be high and may be 98.7% by mass or more or 99.0% by mass or more, for example.

The degree of purity of the boron nitride powder in the present specification means a value calculated by titration. Specifically, the degree of purity is determined by performing titration by a method described in Examples of the present specification.

The boron nitride powder may contain colored particles in addition to the particles of hexagonal boron nitride which are generally colorless. Examples of the colored particles include particles containing carbon and particles having a magnetizing ability. In this regard, the boron nitride powder according to the present embodiment further has a reduced content of the particles containing carbon (hereinafter also referred to as carbon-containing particles) in addition to a high degree of purity. Because the particles containing carbon (hereinafter also referred to as carbon-containing particles) have conductivity in many cases and have a relatively large influence on the properties of the boron nitride powder, an insulation performance can be improved by reducing the content of the carbon-containing particles. The tinge of the above-mentioned colored particles means a tinge different from that of the particles of hexagonal boron nitride and is not specified. The particles containing carbon and the particles having a magnetizing ability are generally brown or black, but the tinge may be changed depending on the content of carbon and the content of a magnetizing component.

The number of the carbon-containing particles in the boron nitride powder is 10 or less per 10 g of the boron nitride powder, where the upper limit value of the number of the carbon-containing particles may be, for example, 9 or less, 8 or less, 7 or less, 5 or less, or 3 or less per 10 g of the boron nitride powder. When the upper limit value of the number of the carbon-containing particles is within the above-mentioned range, the influence on the insulation performance and the like of the boron nitride powder can be more sufficiently prevented. The lower limit value of the number of the carbon-containing particles in the boron nitride powder is not particularly limited, and the carbon-containing particles may not be contained, but the lower limit value may be, for example, 0.05 or more, or 0.1 or more per 10 g of the boron nitride powder. The number of the carbon-containing particles in the boron nitride powder can be adjusted to within the above-mentioned range and may be, for example, 0.05 to 10, or 0.05 to 5 per 10 g of the boron nitride powder.

The number of the carbon-containing particles in the present specification is the number obtained by measuring as follows. First, 10 g of the boron nitride powder to be measured and 100 mL of ethanol are weighed out and put in a container, and stirred with a stirring rod to prepare a mixed solution. Subsequently, the above-mentioned mixed solution is dispersed using an ultrasonic disperser to prepare a dispersion liquid. The obtained dispersion liquid is added into a sieve having an aperture of 63 μm (JIS Z 8801-1:2019 “Test sieves—Test sieves of metal wire cloth”), and thereafter 2 L of distilled water is added thereinto. Furthermore, distilled water is continuously made to flow through the sieve until no cloudy water comes out from under the sieve. Thereafter, the material remaining on the sieve (material on the sieve) is washed with ethanol and sieved to recover the material on the sieve. Ethanol is added to the material on the sieve again, distilled water is further continuously made to flow until no cloudy water comes out from under the sieve, and the material on the sieve is washed with ethanol. Furthermore, the material on the sieve is transferred to a container, 100 mL of ethanol is added, and stirring, dispersion, and sieving treatments are performed in the same manner as the above-mentioned operation. The same operation is repeatedly performed until the ethanol solution passing through the sieve is no longer cloudy.

Thereafter, the material on the sieve obtained as described above is dried to disperse the powder on a powder paper, a permanent magnet is placed under the powder paper, and the powder that is not magnetized by the permanent magnet is dispersed on another powder paper and observed with an optical microscope to count the number of observed colored particles. The same operation is performed on 5 or more samples, and the arithmetic average of the number of the obtained colored particles is calculated to take the average value thereof as the number of the carbon-containing particles per 10 g of the boron nitride powder. Whether carbon is contained or not can be confirmed by measuring with an energy dispersive X-ray spectrometer (EDX).

The boron nitride powder may contain carbon as an impurity. Even when a trace amount of carbon is contained, this may have an influence on properties such as an insulation performance depending on the situation in which the boron nitride powder is used. The content of carbon (impurity carbon) in the boron nitride powder is preferably reduced.

The upper limit value of the amount of impurity carbon in the boron nitride powder may be 170 ppm or less, 165 ppm or less, or 160 ppm or less, for example. When the upper limit value of the amount of impurity carbon is within the above-mentioned range, the insulation performance of the boron nitride powder is better. The lower limit value of the amount of impurity carbon in the boron nitride powder is not particularly limited, and impurity carbon may not be contained, but the lower limit value may be 5 ppm or more, 10 ppm or more, or 15 ppm or more, for example. The amount of impurity carbon in the boron nitride powder may be adjusted to within the above-mentioned range, and may be 5 to 170 ppm, or the like, for example.

The amount of impurity carbon in the present specification means a value measured by a simultaneous carbon/sulfur analyzer. In the measurement of the amount of impurity carbon in the present specification, a powder, in which the above-mentioned carbon-containing particles (having a particle size of 63 μm or more) have been removed from the boron nitride powder to be measured, is used as a powder to be measured. As the simultaneous carbon/sulfur analyzer, for example, an “IR-41.2 type” (product name) manufactured by LECO Corporation, and the like can be used.

The hexagonal boron nitride contained in the boron nitride powder preferably has a high crystallinity. In the boron nitride powder of the present embodiment, a graphitization index (G.I.) can be used as an index of the above-mentioned crystallinity. That is, in the boron nitride powder containing the hexagonal boron nitride having a low graphitization index, the insulation performance is excellent because impurities have been further reduced, and the heat dissipation performance may also be improved because of a high crystallinity. The upper limit value of the graphitization index of the above-mentioned boron nitride powder may be 2.3 or less, 2.2 or less, 2.1 or less, or 2.0 or less, for example. When the upper limit value of the graphitization index of the above-mentioned boron nitride powder is within the above-mentioned range, the boron nitride powder has a better insulation performance. Although the lower limit value of the graphitization index of the above-mentioned boron nitride powder is not particularly limited, it may generally be 1.2 or more, or 1.3 or more for the intention of use as a heat dissipation filler. The graphitization index of the above-mentioned boron nitride powder may be adjusted to within the above-mentioned range and may be 1.2 to 2.3, or the like, for example.

The graphitization index in the present specification is an index also known as an index value indicating the degree of crystallinity of graphite (for example, J. Thomas, et al., J. Am. Chem. Soc. 84, 4619 (1962), and the like). The graphitization index is calculated based on the spectrum of the primary particles of hexagonal boron nitride measured by a powder X-ray diffraction method. First, in an X-ray diffraction spectrum, the area values (in arbitrary units) surrounded by the integrated intensities (that is, each diffraction peak) of each of diffraction peaks corresponding to the plane (100), the plane (101), and the plane (102) of the primary particles of hexagonal boron nitride and by the baselines thereof are calculated to be used as S100, S101, and S102. Using the calculated area values, the value of [(S100+S101)/S102] is calculated to determine the graphitization index. More specifically, the graphitization index is determined by a method described in Examples of the present specification.

The lower limit value of the average particle size of the boron nitride powder may be 7 μm or more, 8 μm or more, 9 μm or more, or 10 in or more, for example. When the lower limit value of the average particle size of the boron nitride powder is within the above-mentioned range, the heat dissipation performance of the boron nitride powder can be further improved. The upper limit value of the average particle size of the boron nitride powder may be 100 μm or less, 90 μm or less, 80 μm or less, or 75 μm or less, for example. When the upper limit value of the boron nitride powder is within the above-mentioned range, a sheet having the thickness of 500 μm or less can be suitably filled with the boron nitride powder. The average particle size of the boron nitride powder can be adjusted to within the above-mentioned range and may be 7 to 100 μm, or 8 to 80 μm, for example. For example, when the boron nitride powder is used by being dispersed in a resin to be molded into a sheet shape, the average particle size of the boron nitride powder can be selected according to the thickness of a sheet.

The average particle size in the present specification is a value obtained by measurement without subjecting the boron nitride powder to homogenizer treatment, and is the average particle size including the agglomerated particles. The average particle size in the present specification is also the particle size at which the cumulative value of the cumulative particle size distribution is 50% (median size, d50). The average particle size in the present specification is measured using a laser diffraction scattering method particle size distribution analyzer in accordance with the description of ISO 13320:2009. Specifically, measurement is performed by a method described in Examples of the present specification. As the laser diffraction scattering method particle size distribution analyzer, for example, “LS-13 320” (product name) manufactured by Beckman Coulter, Inc., and the like can be used.

The lower limit value of the specific surface area of the boron nitride powder may be 0.8 m²/g or more, 1.0 m²/g or more, 1.2 m²/g or more, or 1.4 m²/g or more, for example. When the lower limit value of the specific surface area is within the above-mentioned range, a filler having better filling properties and heat dissipation properties can be provided. The upper limit value of the specific surface area of the boron nitride powder may be 8.0 m²/g or less, 7.5 m²/g or less, 7.0 m²/g or less, or 6.5 m²/g or less, for example. When the upper limit value of the specific surface area is within the above-mentioned range, the insulation performance is better. The specific surface area of the boron nitride powder can be adjusted to within the above-mentioned range and may be 0.8 to 8.0 m²/g, or 1.0 to 7.0 m²/g, for example.

The specific surface area in the present specification means a value measured using a specific surface area measurement device in accordance with the description of “Determination of the specific surface area of powders (solids) by gas adsorption-BET method” of JIS Z 8830:2013, and is a value calculated by applying a single point BET method that uses nitrogen gas. Specifically, measurement is performed by a method described in Examples of the present specification.

The above-mentioned agglomerated particles have voids because they are constituted by agglomeration of a plurality of the primary particles of hexagonal boron nitride. Accordingly, it is desirable to set an index for property evaluation using the value of the average particle size together with the value of the specific surface area. The average particle size and the specific surface area of the above-mentioned boron nitride powder may be adjusted to within the above-mentioned ranges, and for example, the boron nitride powder may have an average particle size of 7 to 100 μm and a specific surface area of 0.8 to 8.0 m²/g, or may have an average particle size of 8 to 80 μm and a specific surface area of 1 to 7 m²/g.

The above-mentioned agglomerated particles preferably have excellent compressive strength. The lower limit value of the compressive strength of the above-mentioned agglomerated particles may be 6 MPa or more, 8 MPa or more, 10 MPa or more, or 12 MPa or more, for example. The upper limit value of the compressive strength of the above-mentioned agglomerated particles may be 20 MPa or less, or 15 MPa or less, for example. The compressive strength of the above-mentioned agglomerated particles may be adjusted to within the above-mentioned range and may be 6 to 20 MPa, or 8 to 15 MPa, for example.

The compressive strength in the present specification means a value measured in accordance with the description of “Test methods of properties of fine ceramic granules, Part 5: Compressive strength of a single granule” of JIS R 1639-5:2007. Specifically, measurement is performed by a method described in Examples of the present specification.

The upper limit value of the orientation index of the above-mentioned boron nitride powder may be 30 or less, 20 or less, 18 or less, or 15 or less, for example. The lower limit value of the orientation index of the above-mentioned boron nitride powder is not particularly limited, but may be 2 or more, 3 or more, or 5 or more, for example. When the upper limit value of the orientation index is within the above-mentioned range, a boron nitride powder having better heat dissipation properties can be provided. The orientation index of the above-mentioned boron nitride powder may be adjusted to within the above-mentioned range and may be 2 to 30, or the like, for example.

The orientation index in the present specification means the ratio between the peak intensity in the plane (002) of boron nitride measured with an X-ray diffractometer and the peak intensity in the plane (100), and can be calculated by [I(002)/I(100)]. Specifically, measurement is performed by a method described in Examples of the present specification.

The boron nitride powder according to the present embodiment has a sufficiently high degree of purity and a reduced content of the carbon-containing particles than that of conventional products, and is thereby able to exhibit a high performance (such as an insulation performance) even when being exposed to harsh environments (such as application of a high voltage for a long period of time). The above-mentioned boron nitride powder can be suitably used as a filler used by being dispersed in resin, rubber, and the like, for example. The above-mentioned boron nitride powder can be suitably used as a constituent material of a heat-transmitting sheet and the like, for example.

[Production Method of Boron Nitride Powder]

The above-mentioned boron nitride powder can be prepared by the following method, for example. A production method of a boron nitride powder of one embodiment includes a step (hereinafter also referred to as an oxidation treatment step) of heat-treating, in an oxygen-containing atmosphere, a raw material powder containing agglomerated particles that are formed by agglomeration of primary particles of hexagonal boron nitride and having a degree of purity of 98.0% by mass or more.

It is sufficient for the above-mentioned raw material powder to contain agglomerated particles formed by agglomeration of primary particles of hexagonal boron nitride and to have a degree of purity of 98.0% by mass or more, and a commercially available boron nitride powder can be used, or a separately prepared powder can also be used. When preparing the raw material powder, for example, preparation is possible by a method of firing boron carbide in an atmosphere containing nitrogen (hereinafter also referred to as B₄C method), a method of firing in an atmosphere containing nitrogen (hereinafter also referred to as a carbon reduction method), and the like.

An example of a preparation method of the raw material powder to which the B₄C method has been applied includes a step of firing a boron carbide powder (B₄C powder) in a nitrogen pressurized atmosphere to obtain a fired material containing boron carbonitride (B₄CN₄) (hereinafter also referred to as nitriding step), and a step of heating the fired material with a mixed powder containing a boron-containing compound containing boric acid to generate flake-like primary particles of hexagonal boron nitride (hBN), thereby obtaining a powder containing agglomerated particles formed by agglomeration of the primary particles (hereinafter also referred to as crystallization step).

As the boron carbide powder, one prepared by the following procedure can also be used, for example. After mixing boric acid and acetylene black, the mixture is heated in an inert gas atmosphere at 1800° C. to 2400° C. for 1 to 10 hours to obtain a boron carbide clump. This boron carbide clump is ground and then appropriately subjected to sieving, washing, removal of impurities, drying, and the like, by which a boron carbide powder can be prepared.

The firing temperature in the nitriding step may be 1800° C. to 2400° C., 1900° C. to 2400° C., 1800° C. to 2200° C., or 1900° C. to 2200° C., for example. By setting the firing temperature within the above-mentioned range, the crystallinity of boron carbonitride can be enhanced, which makes it possible to increase the proportion of hexagonal boron carbonitride. The pressure in the nitriding step may be 0.6 to 1.0 MPa, 0.7 to 1.0 MPa, 0.6 to 0.9 MPa, or 0.7 to 0.9 MPa. By setting the pressure within the above-mentioned range, the nitridation of boron carbide can proceed more sufficiently. On the other hand, when the pressure is too high, the production cost tends to increase.

The nitrogen gas concentration of the nitrogen pressurized atmosphere in the nitriding step may be 95% by volume or more, or 99% by volume or more, for example. The firing time in the nitriding step is not particularly limited as long as the nitridation progresses sufficiently, and may be 6 to 30 hours, or 8 to 20 hours, for example. In the present specification, the firing time means a time (retention time) for maintaining a predetermined temperature after a temperature of the surrounding environment of an object to be heated attains the predetermined temperature.

In the crystallization step, the boron carbonitride obtained in the nitriding step is decarburized, and furthermore, flake-like primary particles having a predetermined size are generated and agglomerated to obtain a boron nitride powder containing clumped particles.

Examples of boron-containing compounds include boron oxide and the like in addition to boric acid. The mixed powder heated in the crystallization step may contain known additives. The mixing ratio with the boron-containing compound can be appropriately set according to the molar ratio. By setting the content of the boron-containing compound in the mixed powder such that the amount of the boron-containing compound is excessive With respect to the boron carbonitride, the degree of purity of the raw material powder can be improved.

The heating temperature for heating the mixed powder in the crystallization step may be 1800° C. to 2200° C., 2000° C. to 2200° C., or 2000° C. to 2100° C., for example. Grain growth can proceed more sufficiently by setting the heating temperature within the above-mentioned range. In the crystallization step, heating may be performed in an atmosphere of normal pressure (atmospheric pressure), or heating may be performed at a pressure exceeding atmospheric pressure by pressurization. The pressure in the case of pressurization may be 0.5 MPa or less, or 0.3 MPa or less, for example.

The heating time in the crystallization step may be 0.5 to 40 hours, 0.5 to 35 hours, or 1 to 30 hours, for example. When the heating time is too short, grain growth tends not to proceed sufficiently. On the other hand, when the heating time is too long, this tends to be industrially disadvantageous.

A hexagonal boron nitride powder can be obtained by the above steps. A grinding step may be performed after the crystallization step. In the grinding step, a general grinding mills or deagglomerator can be used. For example, ball mills, vibration mills, jet mills, and the like can be used. In the present disclosure, “grinding” also includes “deagglomeration”.

An example of a preparation method of the raw material powder to which the carbon reduction method has been applied includes a step of firing a mixed powder containing a boron-containing compound containing boric acid and a carbon-containing compound in a nitrogen pressurized atmosphere to obtain a fired material containing boron nitride (hereinafter also referred to as a low-temperature firing step), and a step of heat-treating the above-mentioned fired material at a temperature higher than that in the above-mentioned step and less than 2050° C. to generate primary particles of hexagonal boron nitride (hBN), thereby obtaining a powder containing agglomerated particles formed by agglomeration of the above-mentioned primary particles (hereinafter also referred to as firing step).

The boron-containing compound is a compound having boron as a constituent element. As the boron-containing compound, a raw material with a high degree of purity and relatively low cost can be used. Examples of such a boron-containing compound include boron oxide in addition to boric acid. The boron-containing compound includes boric acid, but boric acid is dehydrated by heating to become boron oxide, which forms a liquid phase during the heat treatment of the raw material powder and can also function as an aid for promoting grain growth.

The carbon-containing compound is a compound having a carbon atom as a constituent element. As the carbon-containing compound, a raw material with a high degree of purity and relatively low cost can be used. Examples of such a carbon-containing compound include carbon black and acetylene black.

In the mixed powder, the boron-containing compound may be blended in an excess amount with respect to the carbon-containing compound. The mixed powder may contain other compounds in addition to the carbon-containing compound and the boron-containing compound. Examples of the other compounds include boron nitride as a nucleating agent. By incorporating boron nitride as a nucleating agent in the mixed powder, the average particle size of the synthesized hexagonal boron nitride powder can be more easily controlled. The mixed powder preferably contains a nucleating agent. When the mixed powder contains a nucleating agent, the hexagonal boron nitride powder having a small specific surface area (for example, a hexagonal boron nitride powder having a specific surface area of less than 2.0 M/g) is more easily prepared.

The low-temperature firing step is performed under pressure. The pressure in the low-temperature firing step may be 0.25 MPa or more and less than 5.0 MPa, 0.25 to 3.0 MPa, 0.25 to 2.0 MPa, 0.25 to 1.0 MPa, 0.25 MPa or more and less than 1.0 MPa, 0.30 to 2.0 MPa, or 0.50 to 2.0 MPa, for example. By increasing the pressure in the low-temperature firing step, volatilization of the raw material such as the boron-containing compound can be further prevented, and the generation of boron carbide, which is a by-product, can be prevented. Furthermore, by increasing the pressure in the low-temperature firing step, an increase in the specific surface area of the boron nitride powder can be prevented. By setting the upper limit value of the pressure in the low-temperature firing step within the above-mentioned range, the growth of the primary particles of boron nitride can be further promoted.

The heating temperature in the low-temperature firing step may be 1650° C. or higher and lower than 1800° C., 1650° C. to 1750° C., or 1650° C. to 1700° C., for example. By setting the lower limit value of the heating temperature in the low-temperature firing step within the above-mentioned range, the reaction can be promoted, which makes it possible to improve the yield of boron nitride obtained. By setting the upper limit value of the heating temperature in the low-temperature firing step within the above-mentioned range, the generation of by-products can be sufficiently prevented.

The heating time in the low-temperature firing step may be 1 to 10 hours, 1 to 5 hours, or 2 to 4 hours, for example. By maintaining a relatively low temperature for a predetermined time in the step that is an early stage of the reaction for synthesizing boron nitride, the reaction system can be made more homogeneous, by which boron nitride to be formed can be made more homogeneous. In the present specification, the heating time means a time (retention time) for maintaining a predetermined temperature after a temperature of the surrounding environment of an object to be heated attains the predetermined temperature.

The firing step is a step of heat-treating the fired material obtained in the low-temperature firing step at a temperature higher than that of the low-temperature firing step to generate primary particles of hexagonal boron nitride (hBN), thereby obtaining a powder containing agglomerated particles formed by agglomeration of the above-mentioned primary particles.

The heating temperature in the firing step is a temperature higher than that in the low-temperature firing step and lower than 2050° C. The heating temperature in the firing step may be 2000° C. or lower. The heating time in the firing step may be 3 to 15 hours, 5 to 10 hours, or 6 to 9 hours, for example.

The pressure in the firing step m ay be 0.25 MPa or more and less than 5.0 MPa, 0.25 to 3.0 MPa, 0.25 to 2.0 MPa, 0.25 to 1.0 MPa, 0.25 MPa or more and less than 1.0 MPa, 0.30 to 2.0 MPa, or 0.50 to 2.0 MPa, for example. By increasing the pressure in the firing step, the degree of purity of the obtained raw material powder can be further improved. By setting the upper limit value of the pressure in the firing step within the above-mentioned range, the preparation cost of the raw material powder can be further reduced, which is industrially advantageous.

A hexagonal boron nitride powder can be obtained by the above steps. A grinding step may be performed after the low-temperature firing step or the firing step. In the grinding step, a general grinding mills or deagglomerator can be used.

The oxidation treatment step in the production method of a boron nitride powder is a step of heat-treating the raw material powder in the presence of oxygen to convert the carbon content in the raw material powder to carbon dioxide gas, which is then removed out of the system, thereby reducing the residual amount of the carbon content in the raw material powder. By this step, the contents of the carbon-containing particles and the impurity carbon can be further reduced.

The lower limit value of the heating temperature in the oxidation treatment step may be 500° C. or higher, 600° C. or higher, or 700° C. or higher, for example. By setting the lower limit value of the heating temperature within the above-mentioned range, the carbon content in the raw material powder can be further reduced. The upper limit value of the heating temperature in the oxidation treatment step may be less than 1000° C., 900° C. or less, or 800° C. or less, for example. By setting the upper limit value of the heating temperature within the above-mentioned range, excessive oxidation of boron nitride can be prevented while performing decarburization treatment. The heating temperature in the oxidation treatment step may be adjusted to within the above-mentioned range and may be 500° C. or higher and lower than 1000° C., 500° C. to 900° C., or the like, for example.

The pressure in the oxidation treatment step can be adjusted to atmospheric pressure or reduced pressure, for example. The upper limit value of the pressure in the oxidation treatment step may be 150 kPa or less, 130 kPa or less, or 120 kPa or less, for example. The lower limit value of the pressure in the oxidation treatment step is not particularly limited, but may be 15 kPa or more, 20 kPa or more, or 30 kPa or more, for example. The pressure in the oxidation treatment step may be adjusted to within the above-mentioned range and may be 15 to 150 kPa, or the like, for example.

The lower limit value of the proportion of oxygen in the atmosphere in the oxidation treatment step may be 15% by volume or more, 18% by volume or more, or 20% by volume or more, for example. By setting the lower limit value of the proportion of oxygen within the above-mentioned range, the carbon content in the raw material powder can be further reduced. The upper limit value of the proportion of oxygen in the atmosphere in the oxidation treatment step may be 80% by volume or less, 70% by volume or less, or 60% by volume or less, for example. The above-mentioned proportion of oxygen means a value determined by the volume in the standard state. The proportion of oxygen in the atmosphere in the oxidation treatment step may be adjusted to within the above-mentioned range and may be 15 to 80% by volume, or the like, for example.

Although several embodiments have been described above, the present disclosure is not limited to the above-mentioned embodiments. Furthermore, the contents of the descriptions of the above-mentioned embodiments can be applied to each other.

### EXAMPLES

Hereinbelow, the contents of the present disclosure will be described in more detail with reference to examples and comparative examples. However, the present disclosure is not limited to the following examples.

### Example 1

[Preparation of Boron Carbide Powder]

100 parts by mass of orthoboric acid manufactured by Nippon Denko Co., Ltd. and 35 parts by mass of acetylene black (trade name: HIS100L) manufactured by Denka Company Limited were mixed using a Henschel mixer. A crucible made of graphite was filled with the obtained mixture, and heating was performed in an arc furnace in an argon atmosphere at 2200° C. for 6 hours to obtain clumped boron carbide (B₄C). The obtained clumped material was coarsely ground with a jaw crusher to obtain a coarse powder. The obtained coarse powder was further ground by a ball mill having balls (diameter: 10 mm) made of silicon carbide to obtain a ground powder. Grinding by the ball mill was performed for 40 minutes at the rotation speed of 20 rpm. Thereafter, the ground powder was classified using a vibration sieve having an aperture of 90 pun to obtain a boron carbide powder. The carbon content of the obtained boron carbide powder was 19.8% by mass. The carbon content was measured by a simultaneous carbon/sulfur analyzer.

[Preparation of Boron Carbonitride Powder]

The prepared boron carbide powder was heated in a carbon type resistance heating furnace for 12 hours under the condition of the firing temperature of 2050° C. and the pressure of 0.90 MPa in a nitrogen gas atmosphere. Thereby, a fired material containing boron carbonitride (B₄CN₄) was obtained. In addition, the generation of hexagonal boron carbonitride was confirmed as a result of XRD analysis. Thereafter, subsequently, a crucible made of alumina was filled with the above-mentioned fired material, and heating was performed in a muffle furnace for 5 hours under the condition of the air atmosphere and the firing temperature of 700° C.

[Preparation of Raw Material Powder (Boron Nitride Powder)]

The fired material and boric acid were blended at a proportion such that the boric acid was 50 parts by mass with respect to 100 parts by mass of boron carbonitride, and mixed using a Henschel mixer. A crucible made of boron nitride was filled with the obtained mixture, and in a resistance heating furnace, the temperature was raised from room temperature to 1000° C. at the temperature rising rate of 10° C./minutes in a nitrogen gas atmosphere and under the pressure condition of atmospheric pressure. Subsequently, the temperature was raised from 1000° C. to 1880° C. at the temperature rising rate of 2° C./minutes. By heating by retaining the temperature at 1880° C. for 5 hours, a powder containing agglomerated particles formed by agglomeration of primary particles of hexagonal boron nitride was obtained. The obtained powder was deagglomerated for 20 minutes with a Henschel mixer and thereafter passed through a 95 pun sieve to obtain a raw material powder. The raw material powder obtained as above had the degree of purity of 99.2% by mass, the orientation index of 7, and the graphitization index of 2.5.

[Oxidation Treatment Step]

Subsequently, the obtained raw material powder was subjected to the following oxidation treatment. First, 500 g of the raw material powder was subjected to oxidation treatment for 2 hours while stirring the powder at 700° C. and 1 rpm using a rotary kiln furnace in an atmospheric pressure atmosphere (where the proportion of oxygen was 21% by volume), and thereby a powder in which the carbon content (impurity carbon and the like) in the raw material powder had been removed was obtained.

[Drying Step]

The powder obtained as described above was placed on a boron nitride plate and thereafter heated at 400° C. for 30 minutes using a high-temperature dryer in a nitrogen atmosphere to obtain a dried powder. The dried powder was used as a boron nitride powder of Example 1.

### Example 2

The evaluation was performed by preparing a boron nitride powder in the same manner as in Example 1 except that the heating temperature in the oxidation treatment step was changed to 550° C.

### Example 3

The evaluation was performed by preparing a boron nitride powder in the same manner as in Example 1 except that the amount of boric acid in the preparation of the raw material powder was changed to 70 parts by mass, and the firing temperature of the resistance heating furnace was changed to 1950° C.

### Example 4

The evaluation was performed by preparing a boron nitride powder in the same manner as in Example 1 except that the average particle size of the raw material powder was set to 45 μl by changing the time of grinding treatment with the ball mill in the preparation of the boron carbide powder to 60 minutes.

### Example 5

The evaluation was performed by preparing a boron nitride powder in the same manner as in Example 1 except that the average particle size of the raw material powder was set to 10 μm by changing the condition of grinding with the ball mill in the preparation of the boron carbide powder to 50 rpm for 3 hours.

### Example 6

The evaluation was performed by preparing a boron nitride powder in the same manner as in Example 1 except that the amount of boric acid in the preparation of the raw material powder was changed to 55 parts by mass, and the G. I. value of the raw material powder was changed to 2.2 by changing the firing temperature of the resistance heating furnace to 1890° C.

### Example 7

The evaluation was performed by preparing a boron nitride powder in the same manner as in Example 1 except that the G.I. value of the raw material powder was changed to 1.4 by changing the firing temperature of the resistance heating furnace to 2100° C. in the preparation of the raw material powder.

### Example 8

The evaluation was performed by preparing a boron nitride powder in the same manner as in Example 1 except that the condition of grinding with the ball mill in the preparation of the boron carbide powder was set to the rotation speed of 25 rpm for 60 minutes to classify the ground powder thereafter using a vibration sieve having an aperture of 63 μm, that the amount of boric acid in the preparation of the raw material powder was changed to 100 parts by mass, and that the firing temperature of the resistance heating furnace was changed to 2000° C. to thereby change the specific surface area of the raw material powder to 2.7, the average particle size to 30 μm, and the G. I. value to 1.7.

### Comparative Example 1

The evaluation was performed by preparing a boron nitride powder in the same manner as in Example 1 except that the oxidation treatment step and the drying step were not performed.

<Evaluation of Boron Nitride Poxwder>

Each of the boron nitride powders obtained in Examples 1 to 8 and Comparative Example 1 was evaluated for the degree of purity, the graphitization index, the average particle size, the specific surface area, the compressive strength, the orientation index, the amount of impurity carbon, and the number of carbon-containing particles by a measurement method to be described later. Table 1 shows the results.

[Degree of Purity of Boron Nitride Powder]

The boron nitride powder was alkali-decomposed with sodium hydroxide, and ammonia was distilled from the decomposed solution by a steam distillation method and collected in an aqueous boric acid solution. Titration With a normal sulfuric acid solution was performed using this collected liquid as a target. The content of nitrogen atoms (N) in the boron nitride powder was calculated from the titration results. From the obtained content of nitrogen atoms, the content of hexagonal boron nitride (hBN) in the boron nitride powder was determined based on Formula (1), and the degree of purity of the hexagonal boron nitride powder was calculated. 24.818 g/mol was used for the formula weight of hexagonal boron nitride, and 14.006 g/mol was used for the atomic weight of nitrogen atoms.

Content of hexagonal boron nitride (hBN) in sample [% by mass]=content of nitrogen atoms (N) [% by mass]×1.772 Formula (1)

[Graphitization Index of Boron Nitride Powder]

The graphitization index of the boron nitride powder was calculated from the measurement results by a powder X-ray diffraction method. First, in the obtained X-ray diffraction spectrum, the area values (in arbitrary units) surrounded by the integrated intensities (that is, each diffraction peak) of each of diffraction peaks corresponding to the plane (100), the plane (101), and the plane (102) of the primary particles of hexagonal boron nitride and by the baselines thereof were calculated to be used as S100, S101, and S102. Using the area values calculated as above, the graphitization index was determined based on Formula (2) below.

GI=(S100+S101)/S102 Formula (2)

[Average Particle Size of Boron Nitride Powder]

The average particle size of the boron nitride powder was measured in accordance with ISO 13320:2009 using a laser diffraction scattering method particle size distribution analyzer manufactured by Beckman Coulter, Inc. (device name: LS-13 320). The measurement was performed without subjecting the boron nitride powder to homogenizer treatment. In measuring the particle size distribution, water was used as a solvent for dispersing the boron nitride powder, and hexametaphosphoric acid was used as a dispersing agent. At this time, a numerical value of 1.33 was used as the refractive index of water, and a numerical value of 1.80 was used as the refractive index of the boron nitride powder.

[Specific Surface Area of Boron Nitride Powder]

The specific surface area of the boron nitride powder was calculated by applying a single point BET method that used nitrogen gas in accordance with the description of “Determination of the specific surface area of powders (solids) by gas adsorption-BET method” of JIS Z 8830:2013. As a specific surface area measurement device, a specific surface area measurement device (device name: QUANTASORB) manufactured by Yuasa Ionics Co., Ltd. was used. The measurement was performed after the boron nitride powder was dried and degassed at 300° C. for 15 minutes.

[Compressive Strength of Agglomerated Particles]

The compressive strength of the agglomerated particles was measured in accordance with the description of “Test methods of properties of fine ceramic granules, Part 5: Compressive strength of a single granule” of JIS R 1639-5:2007. Regarding a compressive strength c (unit [MPa]), a location at which the cumulative destruction rate of 20 particles was 63.2% was calculated as the compressive strength from a dimensionless number α (α=2.48) which varies according to the position within a particle, a compressive test force P (unit [N]), and a particle size d (unit [μm]) of the agglomerated particles to be measured using the math formula α=α×P/(π×d³).

[Orientation Index of Boron Nitride Powder]

The orientation index of the boron nitride powder was determined from the measurement results by the powder X-ray diffraction method. First, a recess part of a glass cell having the recess part with a depth of 0.2 mm and attached to an X-ray diffractometer (manufactured by Rigaku Corporation, trade name: ULTIMA-IV) was filled with the boron nitride powder, which was then solidified at a set pressure M using a powder sample molding machine (AmenaTec Limited, trade name: PX700) to prepare a measurement sample. When the surface of the infill solidified by the above-mentioned molding machine was not smooth, measurement was performed after manually smoothing the surface. After irradiating the measurement sample with X-rays and performing baseline correction, the peak intensity ratio between the plane (002) and the plane (100) of boron nitride was calculated, and based on this numerical value, the orientation index [I(002)/1(100)] was determined.

[Amount of Impurity Carbon of Boron Nitride Powder]

The amount of impurity carbon of the boron nitride powder was measured by a simultaneous carbon/sulfur analyzer (manufactured by LECO Corporation, trade name: IR-412 type).

[Number of Carbon-Containing Particles of Boron Nitride Powder]

The number of carbon-containing particles was measured as follows. First, 10 g of the boron nitride powder to be measured and 100 mL of ethanol were weighed out and put in a container, and stirred with a stirring rod to prepare a mixed solution. Subsequently, the above-mentioned mixed solution was dispersed using an ultrasonic disperser to prepare a dispersion liquid. The obtained dispersion liquid was added into a sieve having an aperture of 63 μm (JIS Z 8801-1:2019 “Test sieves—Test sieves of metal wire cloth”). Thereafter, 2 L of distilled water was added thereinto, and the distilled water was further continuously made to flow through the sieve until no cloudy water came out from under the sieve. Thereafter, the material remaining on the sieve (material on the sieve) was washed with ethanol and sieved to be recovered. Ethanol was added to the material on the sieve again, distilled water was further continuously made to flow until no cloudy water cane out from under the sieve, and the material on the sieve was washed with ethanol. Furthermore, the material on the sieve was transferred to a container, 100 mL of ethanol was added, and stirring, dispersion, and sieving treatments were performed in the same manner as the above-mentioned operation. The same operation was repeatedly performed until the ethanol solution passed through the sieve was no longer cloudy.

Thereafter, the material on the sieve was dried to disperse the powder on a powder paper, a permanent magnet was placed under the powder paper, and the powder that was not magnetized by the permanent magnet was dispersed on another powder paper and observed with an optical microscope to count the number of observed colored particles. The same operation was performed on 5 or more samples, and the arithmetic average of the number of the obtained colored particles was calculated to take the average value thereof as the number of the carbon-containing particles per 10 g of the boron nitride powder. Whether carbon was contained or not was confirmed by measuring by XRF.

<Performance Evaluation of Boron Nitride Powder>

Performance evaluation of each of the boron nitride powders obtained in Examples 1 to 8 and Comparative Example 1 was performed. Specifically, evaluation as a filler for a heat dissipation sheet was performed. Table 1 shows the results.

[Evaluation of Insulation Performance (Measurement of Dielectric Breakdown Voltage)]

First, a resin sheet containing the boron nitride powder was prepared. A mixture of 100 parts by mass of naphthalene type epoxy resin (manufactured by DIC Corporation, trade name HP4032) and 10 parts by mass of imidazoles (manufactured by SHIKOKU CHEMICAL S CORPORATION, trade name MAVT) as a curing agent was prepared. The boron nitride powder was mixed at the proportion of 55 parts by volume with respect to 100 parts by volume of the above-mentioned mixture, and stirred with a planetary mixer for 15 minutes. After the obtained mixture was applied onto a sheet made of PET, defoaming was performed for 10 minutes under the reduced pressure condition of 500 Pa. An epoxy resin composition was applied onto a film made of polyethylene terephthalate (PET) having the thickness of 0.05 mm so that the thickness after curing was 0.10 mm, and drying was performed by heating at 100° C. for 15 minutes. While applying the contact pressure of 160 kgf/cm² with a press, curing was performed by heating at 180° C. for 180 minutes to obtain a heat dissipation sheet having the thickness of 0.1 mm.

The obtained heat dissipation sheet was evaluated. The measurement of the insulation strength of the heat dissipation sheet was performed in accordance with a method described in JIS C 2110. Specifically, a test sample was produced by processing a sheet-shaped heat dissipation member (heat dissipation sheet) into the size of 5 cm×5 cm, and forming a circular copper layer having the diameter of 25 mm on one surface of the processed heat dissipation member and forming a copper layer on the entire surface of the other surface. Electrodes were disposed so as to sandwich the test sample, and a direct voltage of 1100 V was applied in the state of 65° C. and 90 RH %. After the application, the current-carrying time (referred to as breakdown time) until dielectric breakdown occurred was measured to perform evaluation according to the following criteria. The same evaluation was performed 10 times for each evaluation sample, and the average value thereof was taken as the insulation performance of each evaluation sample.
A: the breakdown time was 300 hours or longer.
B: the breakdown time was equal to or longer than 200 hours and shorter than 300 hours.
C: the breakdown time was equal to or longer than 100 hours and shorter than 200 hours.
D: the breakdown time was equal to or longer than 50 hours and shorter than 100 hours.
E: the breakdown time was shorter than 50 hours.

[Evaluation of Heat Dissipation Performance (Measurement of Thermal Conductivity)]

The same resin sheet (heat dissipation sheet) as the resin sheet for the above-mentioned insulation evaluation was prepared, and an epoxy resin composition was poured onto a silicone sheet to produce a cured body having the length of 10 mm, the width of 10 mm, and the thickness of 0.5 mm which was then used as an evaluation sample. A thermal conductivity H (unit [W/(m·K)]) in the uniaxial press direction of the obtained resin sheet was calculated from the math formula H=T×D×C using measurement values of a thermal diffusivity T (unit [n²/sec]), a density D (unit [kg/m³]), and a specific heat capacity C (unit [J/(kg·K)]). For the thermal diffusivity T, a value measured by performing a laser flash method on a sample obtained by processing the resin sheet into the size of length×width×thickness=10 mm×10 mm×0.3 mm was used. A xenon flash analyzer (manufactured by NETZSCH, trade name: LEA 447 NanoFlash) was used as a measurement device. As the density D, a value measured by an Archimedes' method was used. As the specific heat capacity C, a value measured using a differential scanning calorimeter (manufactured by Rigaku Corporation, trade name: Thermo Plus Evo DSC 8230) was used. Based on the obtained thermal conductivity H, the heat dissipation performance of the boron nitride powder was evaluated according to the following criteria.
A: The thermal conductivity H was 12 W/mK or more.
B: The thermal conductivity H was equal to or more than 9 W/mK and less than 12 W/mK.
C: The thermal conductivity H was equal to or more than 6 W/mK and less than 9 W/mK.
D: The thermal conductivity H was less than 6 W/mK.

TABLE 1

| | | | | | | | Evaluation | |
|---|---|---|---|---|---|---|---|---|
| | | | | | | | | Heat |
| | Boron nitride powder | | | | | | | dissipation |
| | | Specific | Average | | Amount of | Carbon- | Insulation | characteristic |
| | Degree of | surface | particle | | impurity | containing | characteristic | Thermal |
| | purity of BN | area | size | G.I. | carbon | particle | DC isolation | conductivity |
| | [% by mass] | [m²/g] | [μm] | value | [ppm] | [number] | [kV/mm] | [W/mK] |
| Example 1 | 99.5 | 6.0 | 60 | 2.5 | 30 | 0.2 | C | A |
| Example 2 | 99.5 | 6.0 | 60 | 2.5 | 150 | 1.2 | D | A |
| Example 3 | 99.5 | 4.5 | 60 | 2.5 | 30 | 0.2 | B | A |
| Example 4 | 99.5 | 6.0 | 45 | 2.5 | 30 | 0.2 | B | A |
| Example 5 | 99.5 | 6.0 | 10 | 2.5 | 30 | 0.2 | B | C |
| Example 6 | 99.5 | 6.0 | 60 | 2.2 | 30 | 0.2 | B | A |
| Example 7 | 99.5 | 6.0 | 60 | 1.4 | 30 | 0.2 | B | B |
| Example 8 | 99.5 | 2.7 | 30 | 1.7 | 30 | 0.2 | A | A |
| Comparative | 99.4 | 6.0 | 60 | 2.5 | 250 | 10.2 | E | A |
| Example 1 | | | | | | | | |

### INDUSTRIAL APPLICABILITY

According to the present disclosure, a boron nitride powder having a better insulation performance when used as a filler than the conventional boron nitride powder can be provided.

1. A boron nitride powder comprising
agglomerated particles formed by agglomeration of primary particles of hexagonal boron nitride,
wherein a degree of purity is 98.5% by mass or more, and
a number of particles containing carbon is 10 or less per 10 g of the boron nitride powder.

2. The boron nitride powder according to claim 1, wherein the number of particles containing carbon is 0.05 to 10 per 10 g of the boron nitride powder.

3. The boron nitride powder according to claim 1, wherein an amount of impurity carbon is 170 ppm or less.

4. The boron nitride powder according to claim 1, wherein a graphitization index is 2.3 or less.

5. The boron nitride powder according to claim 1, wherein an average particle size is 7 to 100 μm, and a specific surface area is 0.8 to 8.0 m²/g.

6. A production method of a boron nitride powder, the method comprising heat-treating a raw material powder at a temperature of 500° C. or higher in an atmosphere in which an oxygen proportion is 15% by volume or more, the raw material powder containing agglomerated particles that are formed by agglomeration of primary particles and containing hexagonal boron nitride in which a degree of purity is 98.0% by mass or more.

7. The production method according to claim 6, wherein an orientation index of the raw material powder is 30 or less.

8. The production method according to claim 6, wherein a graphitization index of the raw material powder is 2.3 or less.
